(19) United States
(12) Patent Application Publication
(10) Pub. No.: US 2016/0145382 A1
(43) Pub. Date: May 26, 2016

(54) POLYMERIC SURFACTANT

(71) Applicant: HUNTSMAN PETROCHEMICAL LLC, The Woodlands, TX (US)

(72) Inventors: Wei-Yang SU, Spring, TX (US); Donald H CHAMPION, The Woodlands, TX (US)

(21) Appl. No.: 14/651,246

(22) PCT Filed: Jul. 1, 2014
(86) PCT No.: PCT/US14/45001

§ 371 Date: Jun. 11, 2015

Related U.S. Application Data
(60) Provisional application No. 61/857,004, filed on Jul. 22, 2013.

(51) Int. Cl. C08G 63/91; C08L 67/02

(52) U.S. Cl. CPC C08G 63/916; C08L 67/025

(57) ABSTRACT

Surfactant compositions including sulfonated polyester polyethers, and methods of making such compositions, are described. A diol is reacted with an anhydride having residual unsaturation, and the resulting polymer is sulfonated under mild acid-base conditions. Sulfonation occurs at the residual unsaturation. If maleic anhydride is used, sulfonation occurs at locations alpha to carbonyl carbons in the polymer.

### FIELD

Embodiments described herein relate to a new surfactant and compositions using the new surfactant. More specifically, new polymeric surfactants for use in demanding applications are described.

### BACKGROUND

Surfactants are used for many different purposes. Cleaners, detergents, processing aids, agricultural formulations, and lubricants all employ surfactants. Some compositions that use surfactants have challenging chemical and/or physical conditions. Compositions containing salt pose well-known challenges with viscosity and physical instability in using surfactants. High shear environments such as well drilling environments can degrade surfactants. There remains a need in the art for polymeric surfactants that can withstand chemically or physically challenging environments.

### SUMMARY

Surfactant compositions including sulfonated polyester polyethers, and methods of making such compositions, are described. A diol is reacted with an anhydride having residual unsaturation, and the resulting polymer is sulfonated under mild acid-base conditions. Sulfonation occurs at the residual unsaturation. If maleic anhydride is used, sulfonation occurs at locations alpha to carbonyl carbons in the polymer.

Such compositions may include a surfactant having the formula

HO(R¹O)_{q}(R²O)ᵣ[COXR³COO(R¹O)_{q}(R²O)_{r]s}[COR⁶COO(R⁴O)ₜ(R⁵O)ᵤO]_{w}HM^{v}_{(s+w)/v}

wherein R¹, R², R⁴, and R⁵ are each, independently, an alkylene group, X is, at each occurrence, a sulfonate group or an alkylsulfonate group with one or more SO₃⁻ groups attached, q is an integer from 0 and 20, r is an integer from 0 and 20, s is an integer from 1 and 500, t is an integer from 0 to 20, u is an integer from 0 to 20, w is an integer from 1 to 500, and M is a cation of valence v.

### DETAILED DESCRIPTION

The inventors have discovered a type of surfactant that is a sulfonated polyether polyester. The surfactant shows high salt tolerance and surfactant characteristics. The sulfonated polyether polyester is a sulfonated copolymer of a polyether component and a polyester component. The polyether component may have one or more ether linkages, and each polyether portion of the compound may have a different number of ether linkages. Typically, a usable compound will have at least one ether linkage between two adjacent pairs of ester linkages. In other words, an ether linkage will typically appear in the polymer chain on only one side of each ester linkage. The copolymer may be a reaction product of a diol having the general formula HO—(R¹O)_{q}(R⁴O)ᵣ-H, where R¹ and R⁴ are each hydrogen or a C₁ to C₂₂ alkylene group, and an anhydride such as maleic anhydride or other alkylene anhydrides. Examples of the anhydride include methyleneglutaric anhydride, methyleneadipic anhydride, methylenepimelic anhydride, traumatic anhydride, and other simple unsaturated anhydrides having unsaturated carbon chains of varying length attached to the anhydride functionalization. Linear unsaturated anhydrides may also be used, typically with unsaturation at either end of the anhydride to support polymerization at either end of the molecule. The anhydride may be substituted at any convenient location, if desired, (for example citraconic anhydride) to add molecular weight to the sulfonated copolymer. The unsaturation may be a single double bond, or if the carbon chain of the anhydride is sufficiently long, more than one double bond may be present. Multiple double bonds in the anhydride chain may provide the opportunity for polysulfonation between two ester linkages of the polymer.

The anhydride is typically copolymerized with a diol, which may be a C₂ to C₂₄ alkane diol. The diol may also be a polyether diol, which is a molecule having hydrocarbyl chains connected by ether oxygen atoms and terminated at both ends with a hydroxyl group. Polyalkylene glycols such as polyethylene glycol, polypropylene glycol, and polytrimethylene glycol are examples. In general, alkane diols, such as the glycols mention above as well as butane diol, pentane diol, and hexane diol, may be used unchanged or polymerized into polyalkylene glycols. Generally, alkane diols with 2 to 24 carbon atoms may be used unchanged or polymerized into polyalkylene glycols. Typically, the copolymer will have two ester linkages with a polyether chain linking the carbonyl carbons and a polyether chain with one or more ether oxygen atoms extending from the ester oxygens. The copolymer may be substituted, if desired, at any convenient location, to add molecular weight or a desired functionality.

The copolymer may be sulfonated to add surfactant activity. The sulfonate groups typically attach at positions alpha to an ester linkage, for example at the alpha carbon of the carbonyl oxygen atom. The sulfonate groups add anionic charge density to selected locations of the copolymer to provide the linearized charge separation and/or dipole moment that gives rise to surfactant activity.

In aqueous solution, the anionic surfactants described above are associated with cations. The complex has a structure generally according to the following formula:

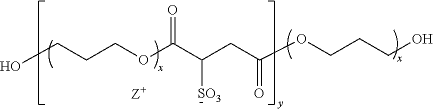

where Z⁺ represents a cation with a single positive charge, examples of which include alkaline metals such as sodium, potassium, and lithium. Molecular cations that may be used to maintain solution of the surfactants described above include ammonium, trialkylammonium, and tris(-hydroxyethyl)ammonium, among others. It should be noted that doubly-charged cations may also maintain solution of the surfactants described above by complexing with two sulfonate groups from the same molecule or different molecules. Alkaline earth metals such as magnesium, calcium, and barium may be used. In the formula above, x may be an integer from 0 to 20 and y may be an integer between 1 and 500.

In the formula above, the repeating unit of the polymeric surfactant is a polyalkoxy alkyl maleate sulfonate, and the molecule is terminated at both ends by an alkanol functionality. In the formula above, a butoxy unit, which may be supplied by tetrahydrofuran, polytetrahydrofuran, or butane-diol, appears at least once between maleate sulfonate linkages, and a butoxy alcohol unit terminates both ends of the molecule. Any alkoxy unit having 2 to 24 carbon atoms may be used to make the polyether. Mixtures of different alkoxy units may also be used, if desired, to adjust properties of the surfactant molecule in a block, random, or repeating manner.

Molecular weight of the surfactant may be adjusted by adjusting the types of units, hydrocarbyl, alkoxy, alcohol, polyether units and/or ester units used, by adjusting the proportions of repeating units, and the extent of polymerization, and by use of substituent groups on either the ester source precursors or the ether source precursors. Sulfonation of the polymer may be adjusted to control valency of the molecule, so that a ratio of valence to molecular weight may be controlled as desired. In addition, a valency pattern may be controlled by controlling distribution of the ester linkages along the polymer chain. For example, in one portion of the molecule, long polyether chains may separate ester linkages, while in another portion of the molecule, shorter polyether chains may separate ester linkages. Sulfonation yields a molecule with a concentration of anionic valency that generally follows the distribution of ester linkages. As mentioned above, supersulfonation may be achieved in some cases by using ester source precursors with multiple unsaturation locations, either along the carbon chain between the carbonyl oxygen atoms or as substituents. If multiple unsaturations are used in an ester source, they may be stabilized, if necessary for purposes of polymerization with diols, by conjugation.

Typically, a ratio of ether linkages to ester linkages is between about 25:1 and about 1:1. The ratio may vary within a particular molecule and from molecule to molecule. Distribution of the ratio may be broad or narrow. A narrow distribution may be achieved by using a single source of ester linkages (anhydrides) and a single source of ether linkages (diols and polyalkylene glycols). It should be noted that the sources of ester and ether linkages in the polymer may contain other functionality and/or substituent groups in some cases, a A broader distribution may be achieved by using a mixture of ester and ether linkage sources. For example, a mixture of maleic anhydride (two carbons between carbonyl oxygens) and methylglutaric anhydride (three carbons between carbonyl oxygens) may be used to broaden the distribution of molecular weight and ester linkages. If the two different anhydrides are used together in a single reaction, a random distribution of two- and three-carbon chains separating carbonyl oxygens will result, while if two different polymerization reactions are performed using the two different ester sources, a block distribution will result in each molecule, with a first end of each molecule having a more dense distribution of ester linkages, and a second end of each molecule having a less dense distribution of ester linkages. Sulfonation density, and anionic charge density, will generally follow this pattern if the molecules are fully sulfonated. If the molecules are partially sulfonated by limiting the sulfonation reagent, the longer chains will sulfonate slightly more than the shorter chains due to the differential proximity of carbonyl oxygens. So, a sulfonation distribution intermediate between the ester linkage distribution may be achieved by controlling degree of sulfonation.

The surfactant molecules described herein may have general formula (1), as follows:

HO(R¹O)_{q}(R²O)ᵣ[COXR³COO(R¹O)_{q}(R²O)_{r]s}[COR⁶COO(R⁴O)ₜ(R⁵O)ᵤO]_{w}HM^{v}_{(s+w)/v}

where R¹, R², R³, R⁴, R⁵, and R⁶ are all, independently, alkylene groups, additionally R³ and R⁵ may be nothing (i.e. X bonded directly to C), and each occurrence of X is an alkylsulfonate group having the formula CₐH_{2a-b}(SO₃⁻)_{b}, where a and b are integers from 1 to 10. The alkylene groups R¹ and R⁴ may be the same or different, and in successive units of R¹O, R²O, R⁴O, and R⁵O , each R¹ may be the same or different, each R² may be the same or different, each R⁴ may be the same or different, and each R⁵ may be the same or different. The constant q is an integer from 0 to 20, such as from 3 to 10, for example 5; the constant r is an integer from 0 to 20, such as from 3 to 10, for example 5; the constant s is an integer from 1 to 500, such as from 10 to 100, for example 50; the constant t is an integer from 0 to 20, such as from 3 to 10, for example 5; the constant u is an integer from 0 to 20, such as from 3 to 10, for example 5; and the constant w is an integer from 1 to 500, such as from 10 to 100, for example 50. In a given surfactant composition, the surfactant molecules present may have a range of structures that generally conform to the structure above, but are different from each other in the alkyl groups present in the polymer chain. The alkyl groups above, R¹-R⁶, may each be, in every independent occurrence, a linear, branched, cyclic, aromatic, bicyclic, or combination of types. In one embodiment R¹ is C₄H₈, R³ is CH₂, R³ and R⁵ are both nothing, every X is CH₂SO₃⁻, r and w are 0, and M is one or more cations of valence v. R¹, R², R⁴, and R⁵ may be selected from the group consisting of ethylene, propylene, butylene, pentylene, and hexylene.

Referring to formula (1), the surfactants described herein generally have the structure AB, where

A=HO(R¹O)_{q}(R²O)ᵣ[COXR³COO(R¹O)_{q}(R²O)_{r]s}

B=[COR⁶COO(R⁴O)ₜ(R⁵O)ᵤO]_{w}H

ignoring the cation species for the moment.

In one aspect, surfactants described herein may have the general formula ABCD, wherein A and C have the general formula

HO(R¹O)_{q}(R²O)ᵣ[COXR³COO(R¹O)_{q}(R²O)_{r]s}

but A and C are different, and B and D have the general formula

[COR⁶COO(R⁴O)ₜ(R⁵O)ᵤO]_{w}H

but B and D are different. In such cases each R¹, R², R³, R⁴, R⁵, R⁶, R⁷, R⁸, R⁹, and R¹⁰ are alkylene groups that may be the same as, or different from each other, each X is a sulfonate group or an alkylsulfonate group with one or more SO₃⁻ groups attached that may be the same as, or different from, every other occurrence of X, and the subscripts q, r, s, t, u, and w may be the same or different in each occurrence. In other words, a surfactant molecule may have a block structure ABCD where block A resembles the sulfonate containing repeating portion of the formula (1) above, and B resembles the non-sulfonate-containing repeating portion of the formula (1) above, but where the blocks A and C are different, and the blocks B and D are different. Alternately, a block structure ABCD may have blocks A and C the same and/or blocks B and D the same.

Such structures may be obtained by staging of polymerization reactions to achieve a desired block structure. To make an AB structure, two intermediate copolymers or multipolymers may be made from two different reaction mixtures, and the two intermediate copolymers may then be reacted together to make the final multipolymer. To make the ABCD structure above, two intermediate polymers AB and CD may be reacted together to form the ABCD structure, and then the ABCD may be sulfonated. To achieve different sulfonate-containing groups, ABCD may be reacted in excess sequentially with a series of different sulfonate-containing precursors until all sulfonate-reactive sites of ABCD are consumed. In some embodiments, an ABA′ structure may be obtained by reacting a polyether diol with two different anhydrides, or by reacting two different polyether diols with one anhydride, and then sulfonating the result. The resulting structure will have a random aspect in that A and A′ may be the same or different in a random fashion.

Molecular weight of the surfactant molecules described herein may range from about 300 to about 50,000, such as between about 2,000 and about 20,000, for example about 10,000. Molecular weight distribution, as measured by ratio of weight-average molecular weight to number-average molecular weight, may be between about 2.1 and about 10.0, such as between about 2.5 and about 9.0, for example about 3.0.

The surfactant molecules described herein may be made by co-polymerizing an anhydride and a diol, and then sulfonating the resulting copolymer. The two reactions are typically performed stepwise, and may be performed in the same vessel or in different vessels. The diol and the anhydride are typically mixed together and condensed. The condensation reaction may be performed in an aqueous environment or in an anhydrous environment. The reaction may be performed by catalyzing with a sulfonic acid such as p-toluenesulfonic acid. Other strong acid catalysts may be employed including sulfuric acid, phosphoric acid, and methanesulfonic acid. Reduced pressure, such as pressure less than about 0.5 atm, for example pressure less than about 0.1 atm, promotes the condensation reaction by removing the water byproduct. Solvents inert to the condensation reaction may be included in the reaction mixture to temper development of viscosity as the mixture polymerizes. Standard alcohols and carboxylic acids may serve as chain growth control reagents, if desired. Catalyst concentration may also control chain length. Temperature during the polymerization reaction is typically maintained between about 80° C. and about 200° C., for example 165° C. The reaction may be quenched when a desired molecular weight is reached as determined, for example, by viscosity or acid number. Quenching may be achieved by decreasing the reaction temperature or by mixing in an acid neutralizer such as sodium hydroxide to remove the catalytic acid.

The sulfonation reaction is typically performed at a moderate pH, such as between about 5.5 and about 8.5, to avoid hydrolyzing the ester linkages. Sodium metabisulfite may be used as the sulfonation reagent, or any other convenient sulfonation reagent such as silver sulfate or sulfur trioxide may be used. A buffer may be used to control pH and/or sulfonic reactivity in the mixture. Typical buffers that may be used include bicarbonate, dihydrogen phosphate, monohydrogen phosphate, and acetate, which may be sodium or potassium salts. Development of viscosity may be controlled by adding water or solvent, and the reaction may be performed at a temperature of about 80° C. to about 200° C. at any convenient pressure, such as atmospheric or ambient pressure.

In one example, a useful surfactant was made by first forming a copolymer intermediate. The copolymer intermediate was formed by mixing together 270.6 g of Terathane 250, which is polytetrahydrofuran having a molecular weight of about 250, with 98.7 g of maleic anhydride and 3.7 g of p-toluene sulfonic acid. After heating the reaction mixture to 165° C. for about 10 hours while removing light byproducts, about 312.2 g of a copolymer intermediate was obtained that had acid number of 16.62 mg KOH/g. About 305 g of the copolymer intermediate was charged to a vessel with 12.8 g of 50% aqueous sodium hydroxide, 117.2 g of deionized water, and 58.2 g of propylene glycol. The mixture was heated to 110-115° C., and then about 98.6 g of sodium metabisulfite was added. About 556.2 g of a somewhat white paste-like surfactant material was obtained that had anionic activity of 1.946 meq/g. A 50 ml aqueous solution containing about 0.1 wt % of the surfactant was shaken in a 100 ml graduated cylinder for one minute. Foam height at 0, 1, and 5 minutes was measured at the 70, 55, and 52 ml marks. A 0.13 wt % solution of the surfactant was prepared, and a 10,000 ppm calcium chloride solution in water was gradually added. The surfactant solution remained clear to a calcium concentration of 2,000 ppm, at which point the surfactant concentration was about 0.10 wt %. The calcium loaded surfactant solution was foam-tested as described above, with foam heights at the 78, 68, and 53 ml marks.

The surfactant molecules described herein have high tolerance to salt in aqueous solutions, as shown above, and inclusion of oxygen in the main chain of the molecule strengthens the molecule in shearing environments, leading to reduced breakdown.

While the foregoing is directed to embodiments of the present invention, other and further embodiments of the invention may be devised without departing from the basic scope thereof, and the scope thereof is determined by the claims that follow.

1. A sulfonated polyether polyester surfactant.

2. The sulfonated polyether polyester surfactant of claim 1, wherein each of the sulfonate groups is alpha to an ester group.

3. The sulfonated polyether polyester surfactant of claim 1, wherein a ratio of ether linkages to ester linkages is between about 25:1 and about 1:1.

4. The sulfonated polyether polyester surfactant of claim 2, wherein the sulfonated polyether polyester surfactant is an anion.

5. The sulfonated polyether polyester surfactant of claim 4, wherein a ratio of molecular weight to valence of the surfactant anion is between 1,000 and 10,000.

6. The sulfonated polyether polyester surfactant of claim 5, further comprising an alkali metal or alkaline earth metal ion.

7. The sulfonated polyether polyester surfactant of claim 3, wherein each ether linkage links two hydrocarbyl chains having between 6 and 24 carbon atoms.

8. The sulfonated polyether polyester surfactant of claim 7, wherein each ester linkage is between a sulfonated hydrocarbyl chain and a polyether chain.

9. A composition comprising a surfactant having the formula
HO(R¹O)_{q}(R²O)ᵣ[COXR³COO(R¹O)_{q}(R²O)_{r]s}[COR⁶COO(R⁴O)ₜ(R⁵O)ᵤO]_{w}HM^{v}_{(s+w)/v}
Wherein R¹, R², R³, R⁴, R⁵, and R⁶ are all, independently, alkylene groups, each occurrence of X is an alkylsulfonate group having the formula CₐH_{2a-b}(SO₃⁻)_{b}, where a and b are integers from 1 to 10, q is an integer from 0 to 20, r is an integer from 0 to 20, s is an integer from 1 to 500, t is an integer from 0 to 20, u is an integer from 0 to 20, w is an integer from 1 to 500, and M is a cation of valence v.

10. The composition of claim 9, further comprising water and a solvent.

11. The composition of claim 10, wherein R¹, R², R⁴ and R⁵ are each, independently, a C₂ to C₂₄ alkylene group.

12. The composition of claim 11, wherein R¹ and R⁴ are each, independently, CH₂, and r and u are 0.

13. The composition of claim 12, wherein the surfactant has a molecular weight between about 300 and about 50,000.

14. The composition of claim 13, wherein the surfactant has a ratio of weight-average molecular weight to number-average molecular weight between about 2.1 and about 10.0.

15. The composition of claim 14, wherein every SO₃⁻ group is alpha to a carbonyl oxygen atom.

16. The composition of claim 15, wherein R¹, R², R⁴, and R⁵ are each selected from the group consisting of ethylene, propylene, butylene, pentylene, and hexylene.

17. A method of making a a surfactant, comprising:
reacting an ester source having unsaturated carbon and an ether source to form a polyester polyether copolymer having unsaturated carbon; and
sulfonating the unsaturated carbon.

18. The method of claim 17, wherein the ester source is an anhydride and the ether source is a diol.

19. The method of claim 18, wherein reacting the ester source having unsaturated carbon and the ether source comprises mixing the ester source having unsaturated carbon and the ether source in a solvent and adding a polymerization catalyst.

20. The method of claim 18, wherein sulfonating the unsaturated carbon comprises forming a reaction mixture of the polyester polyether copolymer having unsaturated carbon and a sulfonating agent and adding a buffer.
